(19) United States
(12) Patent Application Publication
(10) Pub. No.: US 2025/0075150 A1
(43) Pub. Date: Mar. 6, 2025

(54) LIQUID HAND DISHWASHING CLEANING COMPOSITION

(71) Applicant: The Procter & Gamble Company, Cincinnati, OH (US)

(72) Inventors: Jan Julien Marie-Louise BILLIAUW, Gentbrugge (BE); Kristof CRETS, Buggenhout (BE); Phillip Kyle VINSON, Farifield, OH (US)

(21) Appl. No.: 18/818,688

(22) Filed: Aug. 29, 2024

(30) Foreign Application Priority Data
Aug. 29, 2023 (EP) 23193858.0
Mar. 26, 2024 (EP) 24166136.2

(51) Int. Cl. C11D 1/94; C11D 1/14; C11D 1/72; C11D 1/88

(52) U.S. Cl. CPC C11D 1/94; C11D 1/146; C11D 1/72; C11D 1/88

(57) ABSTRACT

A liquid hand dishwashing cleaning composition includes from about 5% to about 50% by weight of the total composition of a surfactant system. The surfactant system includes from about 40% to about 90% by weight of the surfactant system of alkyl sulfated anionic surfactant selected from the group consisting of: alkyl sulfate, alkyl alkoxy sulfate, and mixtures thereof; and a co-surfactant selected from the group consisting of an amphoteric surfactant, a zwitterionic surfactant, and mixtures thereof. The alkyl chains of the alkyl sulfate anionic surfactant have a % mol fraction of C12 to C15 chains of at least about 90%. From about 2.0% to about 15% mol fraction of the alkyl chains of the alkyl sulfated anionic surfactant are C15 alkyl chains.

### TECHNICAL FIELD

The present disclosure relates to a liquid hand dishwashing cleaning composition.

### BACKGROUND

For dishwashing, people desire detergent compositions that provide both effective cleaning, especially grease cleaning, and long-lasting foam. In addition, more people are seeking to wash their dishware in a more sustainable manner. One means of achieving this is by looking for products that contain a greater proportion of ingredients derived from natural renewable resources. However, only small amounts of liquid detergent are used when washing dishware. A large part of the environmental impact from washing dishware comes from using hot water. During manual dishwashing, people will often soak dishware in a wash liquor made from adding a cleaning composition into a sink full of hot water, in an effort to lift grease and greasy residue off the dishware. Indeed, using hot water, having a temperature of around 40° C. has been needed to help lift grease from dishware, when using prior art liquid dishwashing compositions. Moreover, the efficacy of liquid hand dishwashing compositions for grease removal is reduced when the composition is diluted, for instance, when soaking dishware in a sink of wash liquor.

In detergent compositions, including liquid detergent compositions, the viscosity of the composition can play a significant role in user perception and experience. A high viscosity often gives a connotation of richness and quality to users. When it comes to liquid detergent compositions, users often associate a thicker and more viscous consistency with a higher concentration of active ingredients, which they perceive as more effective in cleaning and removing tough stains. This perception of richness can influence consumer purchasing decisions, as they may gravitate towards products with a higher viscosity in the belief that they will deliver superior cleaning performance. However, this preference for high viscosity can present challenges when it comes to cleaning dishes in cold water, as the slower dissolution of the detergent can hinder sudsing and cleaning efficiency. Therefore, finding a balance between viscosity and dissolution rate becomes crucial in developing liquid detergent compositions that meet both user expectations for richness and provide effective cleaning performance, especially in cold water conditions.

Anionic surfactants have been used to provide effective grease cleaning during dishwashing, with alkyl sulfate and alkyl alkoxy sulfates having a high proportion of C12 and C13 chains being found to be particularly effective. Such sulfated surfactants have been derived from synthetic alcohols, such as OXO-alcohols and Fisher Tropsh alcohols. Fractionation can be used to increase the proportion of C12 and C13 alkyl chain. The viscosity and grease cleaning efficacy of compositions containing alkyl sulfate surfactants with C12 and C13 alkyl chains can be significantly impacted by the presence and extent of branching. However, modifying the branching structure to enhance grease cleaning performance often leads to a decrease in viscosity, and conversely, adjusting the branching to achieve the desired viscosity compromises grease cleaning effectiveness. This trade-off becomes particularly pronounced when the C12 to C13 alkyl sulfate anionic surfactant has low degrees of alkoxylation or no alkoxylation. These findings highlight the challenge of simultaneously achieving optimal viscosity and grease cleaning properties in compositions containing such alkyl sulfate surfactants.

Hence, there remains a need to provide improved grease removal from dishware, even when the liquid hand dishwashing composition has been diluted using water at a lower temperature. This need has to be fulfilled without compromising on viscosity of the liquid detergent composition.

EP0466243A1 relates to a process for preparing secondary alkyl sulfate-containing surface active compositions substantially free of unreacted organic matter and water. EP3374486A1 relates to cleaning compositions with improved sudsing profiles, which contain one or more branched and unalkoxylated C6-C14 alkyl sulfate anionic surfactants in combination with one or more linear or branched C4-C11 alkyl or aryl alkoxylated alcohol nonionic surfactants, such cleaning compositions are particularly suitable for use in hand-washing fabrics. WO2017079960A1 relates to cleaning compositions with improved sudsing profiles, which contain the combination of one or more branched, unethoxylated C6-C14 alkyl sulfate surfactants with one or more linear, unalkoxylated C6-C18 alkyl sulfate surfactants, such cleaning compositions are particularly suitable for hand-washing dishes or fabrics. WO2009143091A1 relates to a light duty liquid detergent composition that includes a C14-C15 alcohol and alcohol ethoxylate sulfate surfactant blend as an efficient and effective foaming agent, the surfactant-based product may be a hand dishwashing liquid, a liquid skin cleanser or any type of cleaning or cleansing product based on surfactants, the light duty liquid detergent composition includes an anionic sulfonate surfactant, an amine oxide, a C14-C15 alcohol sulfate, and a C14-C15 alcohol ethoxylate sulfate. WO2017097913A1 relates to a dishwashing detergent composition, including an alkyl sulfate having a branched chain, wherein the refractive index of the dishwashing detergent composition is 0.10 or more to 0.30 or less; the viscosity of the dishwashing detergent composition is 800 mPa·s or more to 1800 mPa·s or less; and the dishwashing detergent composition includes the alkyl sulfate in a content of 0.1% by mass or more to 4.0% by mass or less, based on the total amount of the dishwashing detergent composition. WO1999019449A1 relates to hard surface cleaning products which include mid-chain branched surfactants. WO1997039088A1 relates to mixtures of mid-chain branched primary alkyl sulfate surfactants useful in cleaning compositions, especially for lower water temperature applications, alone or formulated with other surfactants for the purpose of modifying the low temperature cleaning properties of the cleaning formulations, as well as to mid-chain branched primary alkyl sulfate surfactants suitable for use in surfactant mixtures. WO00/42155A1 relates to detergent compositions comprising a pectate lyase and surfactant selected from a mid-chain branched anionic surfactant and/or an amine oxide surfactant, for superior cleaning performance. EP2336282A1 relates to a liquid acidic hard surface cleaning composition having a pH of above 2.0 and comprising formic acid, citric acid and an alkaline material. US2023174893A1 relates to liquid detergent compositions for washing substrates, like fabric, which include a first surfactant which is a mixture of surfactant isomers, and a second surfactant including a linear alkyl benzene sulfonate.

### SUMMARY

The present disclosure relates to a liquid hand dishwashing cleaning composition comprising from 5% to 50% by weight of the total composition of a surfactant system, wherein the surfactant system comprises: from 40% to 90% by weight of the surfactant system of alkyl sulfated anionic surfactant selected from the group consisting of: alkyl sulfate, alkyl alkoxy sulfate, and mixtures thereof; and a co-surfactant selected from the group consisting of an amphoteric surfactant, a zwitterionic surfactant, and mixtures thereof; characterised in that the alkyl chains of the alkyl sulfate anionic surfactant have a % mol fraction of C12 to C15 chains of at least 90%, wherein from 2.0% to 15% mol fraction of the alkyl chains of the alkyl sulfated anionic surfactant are C15 alkyl chains.

The present disclosure further relates to a method of manually washing dishware comprising the steps of: delivering a composition according to the present disclosure to a volume of water to form a wash solution and immersing the dishware in the solution, preferably wherein the water has a temperature of 30° C. or less.

### DETAILED DESCRIPTION

The liquid hand dishwashing cleaning compositions of the present disclosure provide good grease removal, even when immersing dishware in a diluted composition at reduced temperatures, while also providing a more desired viscosity.

### Definitions

As used herein, articles such as “a” and “an” when used in a claim, are understood to mean one or more of what is claimed or described.

The term “comprising” as used herein means that steps and ingredients other than those specifically mentioned can be added. This term encompasses the terms “consisting of” and “consisting essentially of.” The compositions of the present disclosure can comprise, consist of, and consist essentially of the essential elements and limitations of the examples described herein, as well as any of the additional or optional ingredients, components, steps, or limitations described herein.

The term “dishware” as used herein includes cookware and tableware made from, by non-limiting examples, ceramic, china, metal, glass, plastic (e.g., polyethylene, polypropylene, polystyrene, etc.) and wood.

The term “grease” or “greasy” as used herein means materials comprising at least in part (i.e., at least 0.5 wt % by weight of the grease) saturated and unsaturated fats and oils, preferably oils and fats derived from animal sources such as beef, pig and/or chicken.

The terms “include”, “includes” and “including” are meant to be non-limiting.

The term “particulate soils” as used herein means inorganic and especially organic, solid soil particles, especially food particles, such as for non-limiting examples: finely divided elemental carbon, baked grease particle, and meat particles.

The term “sudsing profile” as used herein refers to the properties of a cleaning composition relating to suds character during the dishwashing process. The term “sudsing profile” of a cleaning composition includes suds volume generated upon dissolving and agitation, typically manual agitation, of the cleaning composition in the aqueous washing solution, and the retention of the suds during the dishwashing process. Preferably, hand dishwashing cleaning compositions characterized as having “good sudsing profile” tend to have high suds volume and/or sustained suds volume, particularly during a substantial portion of or for the entire manual dishwashing process. This is important as the consumer uses high suds as an indicator that sufficient cleaning composition has been dosed. Moreover, the consumer also uses the sustained suds volume as an indicator that sufficient active cleaning ingredients (e.g., surfactants) are present, even towards the end of the dishwashing process. The consumer usually renews the washing solution when the sudsing subsides. Thus, a low sudsing cleaning composition will tend to be replaced by the consumer more frequently than is necessary because of the low sudsing level.

It is understood that the test methods that are disclosed in the Test Methods Section of the present application must be used to determine the respective values of the parameters of Applicants' examples as described and claimed herein.

In all embodiments of the present disclosure, all percentages are by weight of the total composition, as evident by the context, unless specifically stated otherwise. All ratios are weight ratios, unless specifically stated otherwise, and all measurements are made at 25° C., unless otherwise designated.

### Cleaning Composition

The cleaning composition is a hand dishwashing cleaning composition in liquid form. The cleaning composition is preferably an aqueous cleaning composition. As such, the composition can comprise from 50% to 85%, preferably from 50% to 75%, by weight of the total composition of water.

Preferably, the pH of the composition is from about 6 to about 14, preferably from about 7 to about 12, or more preferably from about 7.5 to about 10, as measured at 10% dilution in distilled water at 20°° C. The pH of the composition can be adjusted using pH modifying ingredients known in the art.

The composition of the present disclosure can be Newtonian or non-Newtonian, preferably Newtonian. Preferably, the composition has a viscosity of from 10 mPa·s to 10,000 mPa·s, preferably from 100 mPa·s to 5,000 mPa·s, more preferably from 300 mPa·s to 2,000 mPa·s, or most preferably from 500 mPa·s to 1,500 mPa·s, alternatively combinations thereof.

### Surfactant System

The cleaning composition comprises from 5% to 50%, preferably from 8% to 45%, most preferably from 15% to 40%, by weight of the total composition of a surfactant system. In order to improve surfactant packing after dilution and hence improve suds mileage, the surfactant system comprises an alkyl sulfate anionic surfactant and a co-surfactant.

The alkyl sulfate anionic surfactant to the co-surfactant weight ratio can be from 1:1 to 8:1, preferably from 2:1 to 5:1, more preferably from 2.5:1 to 4:1.

### Anionic Surfactant

The surfactant system comprises from 40% to 90%, preferably from 65% to 85%, more preferably from 70% to 80% by weight of the surfactant system of alkyl sulfated anionic surfactant selected form the group consisting of: alkyl sulfate, alkyl alkoxy sulfate, and mixtures thereof. Preferred alkyl alkoxy sulfates are alkyl ethoxy sulfates.

The alkyl chains of the alkyl sulfate anionic surfactant have a % mol fraction of C12 to C15 chains of at least 90%, preferably at least 95%.

From 2.0% to 15%, more preferably from 4.0% to 10% mol fraction of the alkyl chains of the alkyl sulfated anionic surfactant are C15 alkyl chains.

Suds mileage is particularly improved, especially in the presence of greasy soils, when the C13/C12 mol ratio of the alkyl chain is at least 57/43, preferably from 60/40 to 90/10, more preferably from 60/40 to 80/20, most preferably from 60/40 to 70/30, while not compromising suds mileage in the presence of particulate soils.

The average alkyl chain length of the alkyl sulfated anionic surfactant can be from 10 to 14, preferably from 12 to 14, more preferably from 12 to 13 carbon atoms, in order to provide a combination of improved grease removal and enhanced speed of cleaning.

The relative molar amounts of the alkyl chains in the alkyl sulfate anionic surfactant can be derived from the carbon chain length distribution of the anionic surfactant. The carbon chain length distribution of the alkyl chains of the alkyl sulfate anionic surfactants can be obtained from the technical data sheets from the suppliers for the surfactant or constituent alkyl alcohol. Alternatively, the chain length distribution and average molecular weight of the fatty alcohols, used to make the alkyl sulfate anionic surfactant, can also be determined by methods known in the art. Such methods include capillary gas chromatography with flame ionisation detection on medium polar capillary column, using hexane as the solvent. The chain length distribution is based on the starting alcohol and alkoxylated alcohol. As such, the alkyl sulfate anionic surfactant should be hydrolysed back to the corresponding alkyl alcohol and alkyl alkoxylated alcohol before analysis, for instance using hydrochloric acid.

The alkyl sulfated anionic surfactant preferably has an average degree of alkoxylation of 2.0 or less, preferably 0.6 or less, more preferably 0.1 or less. Most preferably the alkyl sulfated anionic surfactant is free of alkoxylation. Such alkyl sulfate anionic surfactants provide improved grease cleaning. The average degree of alkoxylation is the mol average degree of alkoxylation (i.e., mol average alkoxylation degree) of all the alkyl sulfate anionic surfactant. Hence, when calculating the mol average alkoxylation degree, the mols of non-alkoxylated sulfate anionic surfactant are included:

$$Mol average alkoxylation degree = ( x 1 * alkoxylation degree of surfactant 1 + x 2 * alkoxylation degree of surfactant 2 + … ) / ( x 1 + x 2 + … )$$

wherein x1, x2, . . . are the number of moles of each alkyl (or alkoxy) sulfate anionic surfactant of the mixture and alkoxylation degree is the number of alkoxy groups in each alkyl sulfate anionic surfactant.

Preferred alkyl alkoxy sulfates are alkyl ethoxy sulfates

The alkyl sulfated anionic surfactant can have a weight average degree of branching of more than 10%, preferably from 25% to 60%, more preferably from 30% and 50%. The C15 alkyl chains of the alkyl sulfated anionic surfactant can have a weight average degree of branching of more than 10% preferably from 25% to 60%, most preferably from 30% to 50%.

The C12 alkyl chains of the alkyl sulfated anionic surfactant can have a weight average degree of branching of more than 10% preferably from 15% to 60%, most preferably from 20% to 50%. The C13 alkyl chains of the alkyl sulfated anionic surfactant can have a weight average degree of branching of more than 10% preferably from 20% to 60%, most preferably from 25% to 50%. The C14 alkyl chains of the alkyl sulfated anionic surfactant can have a weight average degree of branching of 0% to 20%, preferably from 0% to 15%, more preferably from 0% to 10%.

C2-branching (as measured counting carbon atoms from the sulfate group for non-alkoxylated alkyl sulfate anionic surfactants, and the counting from the alkoxy-group furthest from the sulfate group for alkoxylated alkyl sulfate anionic surfactants) is preferred. The alkyl sulfate anionic surfactant can comprise at least 5%, preferably at least 10%, most preferably at least 25%, by weight of the alkyl sulfate anionic surfactant, of C2-branching.

The branched C15 alkyl sulfated anionic surfactant can comprise C2-branching at a level of greater than 60%, more preferably greater than 80%, most preferably greater than 95% by weight of the branched C15 alkyl content of the alkyl sulfated anionic surfactant.

The C15 alkyl sulfated anionic surfactant can comprise C2-branched C15 alkyl sulfated anionic surfactant, wherein the C2-branched C15 alkyl sulfated anionic surfactant has a mol fraction of 2-methyl and 2-ethyl branched C15 alkyl sulfated anionic surfactant of at least 50% preferably from 60% to 90%, most preferably from 70% to 85%. The C15 alkyl sulfated anionic surfactant can comprise C2-branched C15 alkyl sulfated anionic surfactant, wherein the C2-branched C15 alkyl sulfated anionic surfactant has a mol fraction of 2-methyl branched C15 alkyl sulfated anionic surfactant of at least 40% preferably from 40% to 75%, most preferably from 55% to 65%.

It has been found that formulating the inventive compositions using alkyl sulfate anionic surfactants having the aforementioned degree of branching results in improved low temperature stability, in addition to improved removal of grease when washing at low temperatures under full sink conditions. In addition, such compositions require less solvent in order to achieve good physical stability at low temperatures. As such, the compositions can comprise lower levels of organic solvent, of less than 5.0% by weight of the cleaning composition of organic solvent, while still having improved low temperature stability. Higher surfactant branching also provides faster initial suds generation, but typically less suds mileage. The weight average branching, described herein, has been found to provide improved low temperature stability, initial foam generation and suds longevity.

The weight average degree of branching for an anionic surfactant mixture can be calculated using the following formula:

$$Weight average degree of branching ( \% ) = [ \text{} x 1 * wt \% branched alcohol 1 in alcohol 1 + x 2 * wt \% branched alcohol 2 in alcohol 2 + … ) / ( x 1 + x 2 + … ) ] * 100$$

wherein x1, x2, . . . are the weight in grams of each alcohol in the total alcohol mixture of the alcohols which were used as starting material before (alkoxylation and) sulfation to produce the alkyl (alkoxy) sulfate anionic surfactant. In the weight average degree of branching calculation, the weight of the alkyl alcohol used to form the alkyl sulfate anionic surfactant which is not branched is included.

The weight average degree of branching and the distribution of branching can typically be obtained from the technical data sheet for the surfactant or constituent alkyl alcohol. Alternatively, the branching can also be determined through analytical methods known in the art, including capillary gas chromatography with flame ionisation detection on medium polar capillary column, using hexane as the solvent. The weight average degree of branching and the distribution of branching is based on the starting alcohol used to produce the alkyl sulfate anionic surfactant.

Suitable counterions include alkali metal cation earth alkali metal cation, alkanolammonium or ammonium or substituted ammonium, but preferably sodium.

Suitable examples of commercially available alkyl sulfate anionic surfactants include, those derived from alcohols sold under the Neodol® brand-name by Shell, or the Lial®, Isalchem®, and Safol® brand-names by Sasol, or some of the natural alcohols produced by The Procter & Gamble Chemicals company. The alcohols can be blended in order to achieve the desired mol fraction of C12 and C13 chains and the desired C13/C12 ratio, based on the relative fractions of C13 and C12 within the starting alcohols, as obtained from the technical data sheets from the suppliers or from analysis using methods known in the art.

The performance can be affected by the width of the alkoxylation distribution of the alkoxylated alkyl sulfate anionic surfactant, including grease cleaning, sudsing, low temperature stability and viscosity of the finished product. The alkoxylation distribution, including its broadness can be varied through the selection of catalyst and process conditions when making the alkoxylated alkyl sulfate anionic surfactant.

Without wishing to be bound theory, through tight control of processing conditions and feedstock material compositions, both during alkoxylation especially ethoxylation and sulfation steps, the amount of 1,4-dioxane by-product within alkoxylated especially ethoxylated alkyl sulfates can be kept minimal. A further reduction of 1,4-dioxane by-product can be achieved by a consequent 1,4-dioxane stripping, distillation, evaporation, centrifugation, microwave irradiation, molecular sieving or catalytic or enzymatic degradation step. Processes to control 1,4-dioxane content within alkoxylated/ethoxylated alkyl sulfates have been described extensively in the art. Alternatively 1,4-dioxane level control within detergent formulations has also been described in the art through addition of 1,4-dioxane inhibitors to 1,4-dioxane comprising formulations, such as 5,6-dihydro-3-(4-morpholinyl)-1-[4-(2-oxo-1-piperidinyl) phenyl]-2(1H)-pyridone, 3a-hydroxy-7-oxo-mixture of cholanic acid, 3-(N-methyl amino)-L-alanine, and mixtures thereof. Tight 1,4-dioxane control across the raw material and detergent making process enables product formulations with remaining 1,4-dioxane content of below 10 ppm, preferably below 5 ppm, even more preferably below 1 ppm.

The surfactant system may comprise further anionic surfactant, including sulfonate such as HLAS, or sulfosuccinate anionic surfactants. However, the composition preferably comprises less than 30%, preferably less than 15%, more preferably less than 10% by weight of the surfactant system of further anionic surfactant. Most preferably, the surfactant system comprises no further anionic surfactant, other than the alkyl sulfated anionic surfactant.

### Co-Surfactant

In order to improve surfactant packing after dilution and hence improve suds mileage, the surfactant system comprises a co-surfactant in addition to the anionic surfactant.

Suitable co-surfactants are selected from the group consisting of an amphoteric surfactant, a zwitterionic surfactant, and mixtures thereof. The co-surfactant is preferably an amphoteric surfactant, more preferably an amine oxide surfactant.

The weight ratio of anionic surfactant to the co-surfactant can be from 1:1 to 8:1, preferably from 2:1 to 5:1, more preferably from 2.5:1 to 4:1.

The surfactant system can comprise from 0.1% to 20%, preferably from 0.5% to 15%, more preferably from 2% to 10% by weight of the cleaning composition of the co-surfactant. The surfactant system of the cleaning composition of the present disclosure can comprise from 10% to 40%, preferably from 15% to 35%, more preferably from 20% to 30%, by weight of the surfactant system of the co-surfactant.

The amine oxide surfactant can be linear or branched, though linear are preferred. Suitable linear amine oxides are typically water-soluble, and characterized by the formula R1-N(R2)(R3)O wherein R1 is a C8-18 alkyl, and the R2 and R3 moieties are selected from the group consisting of C1-3 alkyl groups, C1-3 hydroxyalkyl groups, and mixtures thereof. For instance, R2 and R3 can be selected from the group consisting of: methyl, ethyl, propyl, isopropyl, 2-hydroxethyl, 2-hydroxypropyl and 3-hydroxypropyl, and mixtures thereof, though methyl is preferred for one or both of R2 and R3. The linear amine oxide surfactants in particular may include linear C10-C18 alkyl dimethyl amine oxides and linear C8-C12 alkoxy ethyl dihydroxy ethyl amine oxides.

Preferably, the amine oxide surfactant is selected from the group consisting of: alkyl dimethyl amine oxide, alkyl amido propyl dimethyl amine oxide, and mixtures thereof. Alkyl dimethyl amine oxides are preferred, such as C8-18 alkyl dimethyl amine oxides, or C10-16 alkyl dimethyl amine oxides (such as coco dimethyl amine oxide). Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, and mixtures thereof. C12-C14 alkyl dimethyl amine oxide are particularly preferred. Preferably, the alkyl chain of the alkyl dimethyl amine oxide is a linear alkyl chain, preferably a C12-C14 alkyl chain, more preferably a C12-C14 alkyl chain derived from coconut oil or palm kernel oil.

Alternative suitable amine oxide surfactants include mid-branched amine oxide surfactants. As used herein, “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 can be from 10 to 24 carbon atoms, preferably from 12 to 20, and more preferably from 10 to 16. The number of carbon atoms for the one alkyl moiety (n1) is preferably the same or similar to the number of carbon atoms as the one alkyl branch (n2) such that the one alkyl moiety and the one alkyl branch are symmetric. As used herein “symmetric” means that |n1-n2| is less than or equal to 5, preferably 4, most preferably from 0 to 4 carbon atoms in at least 50 wt %, more preferably at least 75 wt % to 100 wt % of the mid-branched amine oxides for use herein. The amine oxide further comprises two moieties, independently selected from a C1-3 alkyl, a C1-3 hydroxyalkyl group, or a polyethylene oxide group containing an average of from 1 to 3 ethylene oxide groups. Preferably, the two moieties are selected from a C1-3 alkyl, more preferably both are selected as C1 alkyl.

Alternatively, the amine oxide surfactant can be a mixture of amine oxides comprising a mixture of low-cut amine oxide and mid-cut amine oxide. The amine oxide of the composition of the present disclosure can then comprise:
a) from 10% to 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls and mixtures thereof; and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof

In a preferred low-cut amine oxide for use herein R3 is n-decyl, with preferably both R1 and R2 being methyl. In the mid-cut amine oxide of formula R4R5R6AO, R4 and R5 are preferably both methyl.

Preferably, the amine oxide comprises less than 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Limiting the amount of amine oxides of formula R7R8R9AO improves both physical stability and suds mileage.

Suitable zwitterionic surfactants include betaine surfactants. Such betaine surfactants includes alkyl betaines, alkylamidobetaine, amidazoliniumbetaine, sulphobetaine (INCI Sultaines) as well as the Phosphobetaine, and preferably meets formula (I):

$${R}^{1} - {[ CO - {X ( {CH}_{2} )}_{n} ]}_{x} - {N}^{+} ( {R}^{2} ) ( {R}_{3} ) - {( {CH}_{2} )}_{m} - {[ CH ( OH ) - {CH}_{2} ]}_{y} - {Y}^{-}$$

wherein in formula (I),
R1 is selected from the group consisting of: a saturated or unsaturated C6-22 alkyl residue, preferably C8-18 alkyl residue, more preferably a saturated C10-16 alkyl residue, most preferably a saturated C12-14 alkyl residue;
X is selected from the group consisting of: NH, NR4 wherein R4 is a C1-4 alkyl residue, O, and S,
n is an integer from 1 to 10, preferably 2 to 5, more preferably 3,
x is 0 or 1, preferably 1,
R2 and R3 are independently selected from the group consisting of: a C1-4 alkyl residue, hydroxy substituted such as a hydroxyethyl, and mixtures thereof, preferably both R2 and R3 are methyl,
m is an integer from 1 to 4, preferably 1, 2 or 3,
y is 0 or 1, and
Y is selected from the group consisting of: COO, SO3, OPO(OR5)O or P(O)(OR5)O, wherein R5 is H or a C1-4 alkyl residue.

Preferred betaines are the alkyl betaines of formula (IIa), the alkyl amido propyl betaine of formula (IIb), the sulphobetaines of formula (IIc) and the amido sulphobetaine of formula (IId):

R¹—N⁺(CH₃)₂—CH₂COO⁻ (IIa)

R¹—CO—NH—(CH₂)₃—N⁺(CH₃)₂—CH₂COO⁻ (IIb)

R¹—N⁺(CH₃)₂—CH₂CH(OH)CH₂SO₃⁻ (IIc)

R¹—CO—NH—(CH₂)₃—N⁺(CH₃)₂—CH₂CH(OH)CH₂SO₃⁻ (IId)
in which R1 has the same meaning as in formula (I). Particularly preferred are the carbobetaines [i.e. wherein Y⁻═COO— in formula (I)] of formulae (IIa) and (IIb), more preferred are the alkylamidobetaine of formula (IIb).

Suitable betaines can be selected from the group consisting or [designated in accordance with INCI]: capryl/capramidopropyl betaine, cetyl betaine, cetyl amidopropyl betaine, cocamidoethyl betaine, cocamidopropyl betaine, cocobetaines, decyl betaine, decyl amidopropyl betaine, hydrogenated tallow betaine/amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kernelamidopropyl betaine, stearamidopropyl betaine, stearyl betaine, tallowamidopropyl betaine, tallow betaine, undecylenamidopropyl betaine, undecyl betaine, and mixtures thereof. Preferred betaines are selected from the group consisting of: cocamidopropyl betaine, cocobetaines, lauramidopropyl betaine, lauryl betaine, myristyl amidopropyl betaine, myristyl betaine, and mixtures thereof. Cocamidopropyl betaine is particularly preferred.

### Nonionic Surfactant

The surfactant system can comprise a nonionic surfactant. It is believed that the addition of the nonionic surfactant reduces viscosensitivity towards variations in starting alcohol in the alkyl sulfate anionic surfactant, and improves the ability to reach the desired viscosity values as well as improving low temperature stability, suds mileage and grease cleaning, which means that less branching at positions greater than C2 is required in the alkyl sulfate surfactant. As such, the addition of the nonionic surfactant enables more flexibility in the choice of starting alcohols of use to make the alkyl sulfate anionic surfactant of the present compositions.

The nonionic surfactant is preferably selected from the group consisting of: alkoxylated alkyl alcohol, alkyl polyglucoside, and mixtures thereof, more preferably the nonionic surfactant is selected from alkoxylated alkyl alcohols, most preferably ethoxylated alcohols.

The surfactant system can comprise the nonionic surfactant at a level of from 1% to 25%, preferably from 1.25% to 15%, more preferably from 1.5% to 10%, by weight of the surfactant system.

Suitable alkoxylated non-ionic surfactants can be linear or branched, primary or secondary alkyl alkoxylated non-ionic surfactants. The alkoxylated nonionic surfactant can comprise on average of from 8 to 18, preferably from 9 to 15, more preferably from 10 to 14 carbon atoms in its alkyl chain.

Alkyl ethoxylated non-ionic surfactant are preferred. Suitable alkyl ethoxylated non-ionic surfactants can comprise an average of from 5 to 12, preferably from 6 to 10, more preferably from 7 to 8, units of ethylene oxide per mole of alcohol. Such alkyl ethoxylated nonionic surfactants can be derived from synthetic alcohols, such as OXO-alcohols and Fisher Tropsh alcohols, or from naturally derived alcohols, or from mixtures thereof. Suitable examples of commercially available alkyl ethoxylate nonionic surfactants include, those derived from synthetic alcohols sold under the Neodol® brand-name by Shell, or the Lial®, Isalchem®, and Safol® brand-names by Sasol, or some of the natural alcohols produced by The Procter & Gamble Chemicals company.

Suitable nonionic surfactants include alkyl polyglucoside (“APG”) surfactants. Alkyl polyglucoside nonionic surfactants are typically more sudsing than other nonionic surfactants such as alkyl ethoxlated alcohols.

A combination of alkylpolyglucoside and alkyl sulfate anionic surfactant has been found to improved polymerized grease removal, suds mileage performance, reduced viscosity variation with changes in the surfactant and/or system, and a more sustained Newtonian rheology.

The alkyl polyglucoside surfactant can be selected from C6-C18 alkyl polyglucoside surfactant. The alkyl polyglucoside surfactant can have a number average degree of polymerization of from 0.1 to 3.0, preferably from 1.0 to 2.0, more preferably from 1.2 to 1.6. The alkyl polyglucoside surfactant can comprise a blend of short chain alkyl polyglucoside surfactant having an alkyl chain comprising 10 carbon atoms or less, and mid to long chain alkyl polyglucoside surfactant having an alkyl chain comprising greater than 10 carbon atoms to 18 carbon atoms, preferably from 12 to 14 carbon atoms.

Short chain alkyl polyglucoside surfactants have a monomodal chain length distribution between C8-C10, mid to long chain alkyl polyglucoside surfactants have a monomodal chain length distribution between C10-C18, while mid chain alkyl polyglucoside surfactants have a monomodal chain length distribution between C12-C14. In contrast, C8 to C18 alkyl polyglucoside surfactants typically have a monomodal distribution of alkyl chains between C8 and C18, as with C8 to C16 and the like. As such, a combination of short chain alkyl polyglucoside surfactants with mid to long chain or mid chain alkyl polyglucoside surfactants have a broader distribution of chain lengths, or even a bimodal distribution, than non-blended C8 to C18 alkyl polyglucoside surfactants. Preferably, the weight ratio of short chain alkyl polyglucoside surfactant to long chain alkyl polyglucoside surfactant is from 1:1 to 10:1, preferably from 1.5:1 to 5:1, more preferably from 2:1 to 4:1. It has been found that a blend of such short chain alkyl polyglucoside surfactant and long chain alkyl polyglucoside surfactant results in faster dissolution of the detergent solution in water and improved initial sudsing, in combination with improved suds stability.

The anionic surfactant and alkyl polyglucoside surfactant can be present at a weight ratio of from greater than 1:1 to 10:1, preferably from 1.5:1 to 5:1, more preferably from 2:1 to 4:1

C8-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation). Glucopon® 215UP is a preferred short chain APG surfactant. Glucopon® 600CSUP is a preferred mid to long chain APG surfactant.

### Further Ingredients

The composition can comprise further ingredients such as those selected from: amphiphilic alkoxylated polyalkyleneimines, cyclic polyamines, triblock copolymers, salts, hydrotropes, organic solvents, other adjunct ingredients such as those described herein, and mixtures thereof.

### Amphiphilic Alkoxylated Polyalkyleneimine:

The composition of the present disclosure may further comprise from 0.05% to 2%, preferably from 0.07% to 1% by weight of the total composition of an amphiphilic polymer. Suitable amphiphilic polymers can be selected from the group consisting of: amphiphilic alkoxylated polyalkyleneimine and mixtures thereof. The amphiphilic alkoxylated polyalkyleneimine polymer has been found to reduce gel formation on the hard surfaces to be cleaned when the liquid composition is added directly to a cleaning implement (such as a sponge) before cleaning and consequently brought in contact with heavily greased surfaces, especially when the cleaning implement comprises a low amount to nil water such as when light pre-wetted sponges are used.

A preferred amphiphilic alkoxylated polyethyleneimine polymer has the general structure of formula (I):

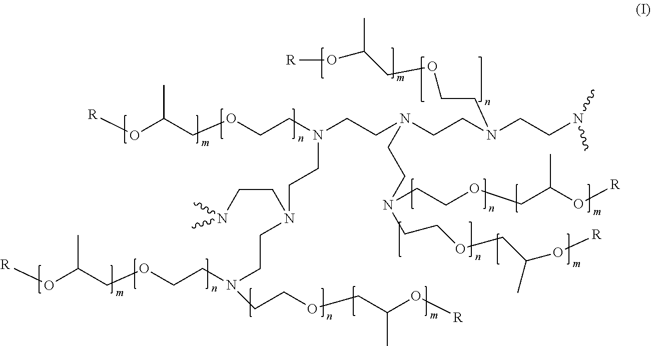

wherein the polyethyleneimine backbone has a weight average molecular weight of 600, n of formula (I) has an average of 10, m of formula (I) has an average of 7 and R of formula (I) is selected from hydrogen, a C₁-C₄ alkyl and mixtures thereof, preferably hydrogen. The degree of permanent quaternization of formula (I) may be from 0% to 22% of the polyethyleneimine backbone nitrogen atoms. The molecular weight of this amphiphilic alkoxylated polyethyleneimine polymer preferably is between 10,000 and 15,000 Da.

More preferably, the amphiphilic alkoxylated polyethyleneimine polymer has the general structure of formula (I) but wherein the polyethyleneimine backbone has a weight average molecular weight of 600 Da, n of Formula (I) has an average of 24, m of Formula (I) has an average of 16 and R of Formula (I) is selected from hydrogen, a C₁-C₄ alkyl and mixtures thereof, preferably hydrogen. The degree of permanent quaternization of Formula (I) may be from 0% to 22% of the polyethyleneimine backbone nitrogen atoms and is preferably 0%. The molecular weight of this amphiphilic alkoxylated polyethyleneimine polymer preferably is between 25,000 and 30,000, most preferably 28,000 Da.

The amphiphilic alkoxylated polyethyleneimine polymers can be made by the methods described in more detail in PCT Publication No. WO 2007/135645.

### Cyclic Polyamine

The composition can comprise a cyclic polyamine having amine functionalities that helps cleaning. The composition of the present disclosure preferably comprises from 0.1% to 3%, more preferably from 0.2% to 2%, and especially from 0.5% to 1%, by weight of the composition, of the cyclic polyamine.

The cyclic polyamine has at least two primary amine functionalities. The primary amines can be in any position in the cyclic amine but it has been found that in terms of grease cleaning, better performance is obtained when the primary amines are in positions 1,3. It has also been found that cyclic amines in which one of the substituents is —CH3 and the rest are H provided for improved grease cleaning performance.

Accordingly, the most preferred cyclic polyamine for use with the cleaning composition of the present disclosure are cyclic polyamine selected from the group consisting of: 2-methylcyclohexane-1,3-diamine, 4-methylcyclohexane-1,3-diamine and mixtures thereof. These specific cyclic polyamines work to improve suds and grease cleaning profile through-out the dishwashing process when formulated together with the surfactant system of the composition of the present disclosure.

Suitable cyclic polyamines can be supplied by BASF, under the Baxxodur tradename, with Baxxodur ECX-210 being particularly preferred.

A combination of the cyclic polyamine and magnesium sulfate is particularly preferred. As such, the composition can further comprise magnesium sulfate at a level of from 0.001% to 2.0%, preferably from 0.005% to 1.0%, more preferably from 0.01% to 0.5% by weight of the composition.

### Triblock Copolymer

The composition of the present disclosure can comprise a triblock copolymer. The triblock co-polymers can be present at a level of from 0.1% to 10%, preferably from 0.5% to 7.5%, more preferably from 1% to 5%, by weight of the total composition. Suitable triblock copolymers include alkylene oxide triblock co-polymers, defined as a triblock co-polymer having alkylene oxide moieties according to Formula (I): (EO)x(PO)y(EO)x, wherein EO represents ethylene oxide, and each x represents the number of EO units within the EO block. Each x can independently be on average of from 5 to 50, preferably from 10 to 40, more preferably from 10 to 30. Preferably x is the same for both EO blocks, wherein the “same” means that the x between the two EO blocks varies within a maximum 2 units, preferably within a maximum of 1 unit, more preferably both x's are the same number of units. PO represents propylene oxide, and y represents the number of PO units in the PO block. Each y can on average be from between 28 to 60, preferably from 30 to 55, more preferably from 30 to 48.

Preferably the triblock co-polymer has a ratio of y to each x of from 3:1 to 2:1. The triblock co-polymer preferably has a ratio of y to the average x of 2 EO blocks of from 3:1 to 2:1. Preferably the triblock co-polymer has an average weight percentage of total EO of between 30% and 50% by weight of the tri-block co-polymer. Preferably the triblock co-polymer has an average weight percentage of total PO of between 50% and 70% by weight of the triblock co-polymer. It is understood that the average total weight % of EO and PO for the triblock co-polymer adds up to 100%. The triblock co-polymer can have an average molecular weight of between 2060 and 7880, preferably between 2620 and 6710, more preferably between 2620 and 5430, most preferably between 2800 and 4700. Average molecular weight is determined using a 1H NMR spectroscopy (see Thermo scientific application note No. AN52907).

Triblock co-polymers have the basic structure ABA, wherein A and B are different homopolymeric and/or monomeric units. In this case A is ethylene oxide (EO) and B is propylene oxide (PO). Those skilled in the art will recognize the phrase “block copolymers” is synonymous with this definition of “block polymers”.

Triblock co-polymers according to Formula (I) with the specific EO/PO/EO arrangement and respective homopolymeric lengths have been found to enhances suds mileage performance of the liquid hand dishwashing detergent composition in the presence of greasy soils and/or suds consistency throughout dilution in the wash process.

Suitable EO-PO-EO triblock co-polymers are commercially available from BASF such as Pluronic® PE series, and from the Dow Chemical Company such as Tergitol™ L series. Particularly preferred triblock co-polymer from BASF are sold under the tradenames Pluronic® PE6400 (MW ca 2900, ca 40 wt % EO) and Pluronic® PE 9400 (MW ca 4600, 40 wt % EO). Particularly preferred triblock co-polymer from the Dow Chemical Company is sold under the tradename Tergitol™ L64 (MW ca 2700, ca 40 wt % EO).

Preferred triblock co-polymers are readily biodegradable under aerobic conditions.

The composition of the present disclosure may further comprise at least one active selected from the group consisting of: salt, hydrotrope, organic solvent, and mixtures thereof.

### Salt:

The composition of the present disclosure may comprise from 0.05% to 2%, preferably from 0.1% to 1.5%, or more preferably from 0.5% to 1%, by weight of the total composition of a salt, preferably a monovalent or divalent inorganic salt, or a mixture thereof, more preferably selected from: sodium chloride, sodium sulfate, and mixtures thereof. Sodium chloride is most preferred.

### Hydrotrope:

The composition of the present disclosure may comprise from 0.1% to 10%, or preferably from 0.5% to 10%, or more preferably from 1% to 10% by weight of the total composition of a hydrotrope or a mixture thereof, preferably sodium cumene sulfonate.

### Organic Solvent:

The composition can comprise from 0.1% to 10%, or preferably from 0.5% to 10%, or more preferably from 1% to 10% by weight of the total composition of an organic solvent. Suitable organic solvents include organic solvents selected from the group consisting of: alcohols, glycols, glycol ethers, and mixtures thereof, preferably alcohols, glycols, and mixtures thereof. Ethanol is the preferred alcohol. Polyalkyleneglycols, especially polypropyleneglycol (PPG), are the preferred glycol. The polypropyleneglycol can have a molecular weight of from 400 to 3000, preferably from 600 to 1500, more preferably from 700 to 1300. The polypropyleneglycol is preferably poly-1,2-propyleneglycol.

### Adjunct Ingredients

The cleaning composition may optionally comprise a number of other adjunct ingredients such as builders (preferably citrate), chelants, conditioning polymers, other cleaning polymers, surface modifying polymers, structurants, emollients, humectants, skin rejuvenating actives, enzymes, carboxylic acids, scrubbing particles, perfumes, malodor control agents, pigments, dyes, opacifiers, pearlescent particles, inorganic cations such as alkaline earth metals such as Ca/Mg-ions, antibacterial agents, preservatives, viscosity adjusters (e.g., salt such as NaCl, and other mono-, di-and trivalent salts) and pH adjusters and buffering means (e.g. carboxylic acids such as citric acid, HCl, NaOH, KOH, alkanolamines, carbonates such as sodium carbonates, bicarbonates, sesquicarbonates, and alike).

### Method of Washing

The compositions of the present disclosure can be used in methods of manually washing dishware.

Preferred methods include the step of delivering a liquid hand dishwashing composition of the present disclosure to a volume of water to form a wash solution and immersing the dishware in the solution, preferably wherein the water has a temperature of 30° C. or less. The dishware is cleaned with the composition in the presence of water.

Typically from 0.5 mL to 20 mL, preferably from 3 mL to 10 mL of the detergent composition, preferably in liquid form, can be added to the water to form the wash liquor. The actual amount of detergent composition used will be based on the judgment of the user, and will typically depend upon factors such as the particular product formulation of the detergent composition, including the concentration of active ingredients in the detergent composition, the number of soiled dishes to be cleaned, the degree of soiling on the dishes, and the like.

The detergent composition can be combined with from 2.0 L to 20 L, typically from 5.0 L to 15 L of water to form the wash liquor, such as in a sink. The soiled dishware is immersed in the wash liquor obtained, before scrubbing the soiled surface of the dishware with a cloth, sponge, or similar cleaning implement. The cloth, sponge, or similar cleaning implement is typically contacted with the dishware for a period of time ranged from 1 to 10 seconds, although the actual time will vary with each application and user preferences.

Optionally, the dishware can be subsequently rinsed. By “rinsing”, it is meant herein contacting the dishware cleaned with the process according to the present disclosure with substantial quantities water. By “substantial quantities”, it is meant usually from 1.0 to 20 L, or under running water.

Alternatively, the composition herein can be applied in its neat form to the dishware to be treated. By “in its neat form”, it is meant herein that said composition is applied directly onto the surface to be treated, or onto a cleaning device or implement such as a brush, a sponge, a nonwoven material, or a woven material, without undergoing any significant dilution by the user (immediately) prior to application. “In its neat form”, also includes slight dilutions, for instance, arising from the presence of water on the cleaning device, or the addition of water by the consumer to remove the remaining quantities of the composition from a bottle. Therefore, the composition in its neat form includes mixtures having the composition and water at ratios ranging from 50:50 to 100:0, preferably 70:30 to 100:0, more preferably 80:20 to 100:0, even more preferably 90:10 to 100:0 depending on the user habits and the cleaning task.

Such methods of neat application comprise the step of contacting the liquid hand dishwashing detergent composition in its neat form, with the dish. The composition may be poured directly onto the dish from its container. Alternatively, the composition may be applied first to a cleaning device or implement such as a brush, a sponge, a nonwoven material, or a woven material. The cleaning device or implement, and consequently the liquid dishwashing composition in its neat form, is then directly contacted to the surface of each of the soiled dishes, to remove said soiling. The cleaning device or implement is typically contacted with each dish surface for a period of time range from 1 to 10 seconds, although the actual time of application will depend upon factors such as the degree of soiling of the dish. The contacting of said cleaning device or implement to the dish surface is preferably accompanied by concurrent scrubbing

Subsequently, the dishware can be rinsed, either by submersing in clean water or under running water.

Another aspect of the present disclosure is directed to use of a hand dishwashing cleaning composition of the present disclosure for providing improved removal of grease when washing dishware at such low temperatures, especially when the liquid detergent composition is diluted to form a wash liquor.

### Packaged Product

The hand dishwashing detergent composition can be packaged in a container, typically plastic containers. Suitable containers comprise an orifice. Suitable containers include traditional upright dosing containers, where the orifice is at the top of the container, and inverted/bottom dosing containers, where the orifice is at the bottom of the container. For inverted/bottom dosing containers, the orifice may be capped and/or the orifice may comprise a slit valve, such as described in U.S. Pat. No. 10,611,531. Typically, the container comprises a cap, with the orifice typically comprised on the cap. The cap can comprise a spout, with the orifice at the exit of the spout. The spout can have a length of from 0.5 mm to 10 mm.

The orifice can have an open cross-sectional surface area at the exit of from 3 mm2 to 20 mm2, preferably from 3.8 mm2 to 12 mm2, more preferably from 5 mm2 to 10 mm2, wherein the container further comprises the composition according to the present disclosure. The cross-sectional surface area is measured perpendicular to the liquid exit from the container (that is, perpendicular to the liquid flow during dispensing).

The container can typically comprise from 200 ml to 5,000 ml, preferably from 350 ml to 2000 ml, more preferably from 400 ml to 1,000 ml of the liquid hand dishwashing detergent composition.

### TEST METHODS

The following assays set forth must be used in order that the examples described and claimed herein may be more fully understood.

### Test Method 1: pH

The pH is measured as a 10% solution in demineralized water at 20° C., unless specified otherwise.

### Test Method 2: Grease Lift-Off and Emulsification

The grease lift-off and emulsification benefit from the different compositions when diluted, and the impact of wash liquor temperature, was assessed using the following procedure:

The test liquid hand dishwashing composition was diluted in water having a water hardness of 7 dH (125 ppm CaCO₃ equivalent) to a level of 10% by weight of the liquid hand dishwashing composition in the water. 150 ml of the resultant wash liquor was added to a glass jar (212 ml jar supplied from Covera, item reference: 2051/TOC58-OB/01). The jars containing the wash liquors were maintained at the test temperature (either 22°° C. or 46° C.).
A 25:75 wt ratio of olive oil and consumer average beef fat (CABF, L2802405/200B3/E3 supplied by: J&R coordinating services Inc, Ohio, USA) was blended together by heating the CABF to 50° C. and then blending in the olive oil to the desired ratio, while mixing using an overhead mixer at 100 rpm for 10 minutes. The grease mix was coated on to a polypropylene spoon (supplied by AVA, Material name 00561586, “Lepel Herbruikbaar Wit PP 18 cm 50 Stuks WIT”) and the spoon placed in the jar containing the wash liquor. The time required for the grease blend to be lifted off the spoon was measured. The end point is determined visually, the grease coming off as a big lump, which floats to the top, estimated to represent 90% grease lift-off.

### Test Method 2: Viscosity Measurement

The viscosity is measured at 20° C. with a Brookfield RT Viscometer using spindle 31 with the RPM of the viscometer adjusted to achieve a torque of between 40% and 60%.

### EXAMPLE

The following examples are provided to further illustrate the present disclosure and are not to be construed as limitations of the present disclosure, as many variations of the present disclosure are possible without departing from its scope.

### Example 1: Inventive and Comparative Compositions

The grease lift-off benefit of compositions of the present disclosure was evaluated against that of comparative compositions.

Liquid hand dishwashing detergent compositions were prepared using alkyl sulfate anionic surfactants based on the starting alcohol blends summarized in table 1 and table 2.

The following alcohol blends were prepared by mixing the following alkyl alcohols:

TABLE 1
Alcohol blend used to make alkyl sulfate anionic surfactants (wt %)

| | Safol ® | Neodol ® | Alcohol | Exxal ® | MARLIPAL | Alcohol |
|---|---|---|---|---|---|---|
| | 23¹ | 3² | 1³ | 1315LE⁴ | 24⁵ | 2⁶ |
| Blend 1 | 50 | 30 | 0 | 20 | 0 | 0 |
| Blend A* | 50 | 30 | 0 | 0 | 20 | 0 |
| Blend B* | 50 | 50 | 0 | 0 | 0 | 0 |
| Blend C* | 50 | 30 | 20 | 0 | 0 | 0 |
| Blend D* | 50 | 30 | 0 | 0 | 0 | 20 |

*for making alkyl sulfates for use in comparative compositions
¹C12 and C13 branched and linear alcohols, supplied by Sasol
²C13 branched (~20%, primarily C2) and linear (~80%) alcohols, supplied by Shell
³Primarily C13 branched and linear alcohols of alcohol example 1 from EP3919594
⁴Primarily C13 and C15 branched and linear (~60%) alcohols, supplied by Exxon
⁵Natural (i.e. linear) mid cut alcohol (C12-C14), supplied by Sasol
⁶Alcohol from example 1 of US2023174893A1

The resulting blends had the following alkyl chain and branching distributions:

TABLE 2
alkyl chain distributions of the alcohol blends of table 1 (mol %):

| | mol % | mol % | mol % | mol % | mol % | mol % |
|---|---|---|---|---|---|---|
| | C12 | C13 | C14 | C15 | C16 | C12-C15 |
| Blend 1 | 27.5 | 65.9 | 0 | 6.6 | 0 | 100 |
| Blend A* | 41.5 | 52.5 | 5 | 0 | 1 | 99 |
| Blend B* | 27.5 | 72.5 | 0 | 0 | 0 | 100 |
| Blend C* | 27.5 | 72.5 | 0 | 0 | 0 | 100 |
| Blend D* | 27.5 | 52.5 | 0 | 20 | 0 | 100 |

TABLE 3
% total branching in the blends of table 1, and % of C2 branching
that is methyl, ethyl and methyl, and propyl or greater:

| | | | | mol % | mol % | mol % | mol % |
|---|---|---|---|---|---|---|---|
| | | mol % | mol % | C2 methyl | C2 | 2-Me | 2-Me—C15 |
| | mol % | C2 | C2 methyl | or ethyl | propyl + | branched/% | branched/% |
| | branched | branched | branched | branched | branched | C2 branched | 2-C15 branched |
| Blend 1 | 38.0 | 15.6 | 8.9 | 11.1 | 4.5 | 57 | 55 |
| Blend A* | 30.6 | 8.2 | 4.9 | 5.9 | 2.3 | 60 | — |
| Blend B* | 34.4 | 12 | 6.6 | 8.2 | 3.8 | 55 | — |
| Blend C* | 47.9 | 25.4 | 10.7 | 15.0 | 10.4 | 42 | — |
| Blend D* | 47.9 | 25.4 | 10.7 | 15.0 | 10.4 | 42 | 34 |

“mol % branched” refers to the mol percentage of the alkyl chains having branching. “mol % C2 branched” refers to the mol percentage of the alkyl chains having branching at the C2 position. “mol % C2 methyl branched” refers to the mol percentage of the alkyl chains having methyl branching at the C2 position. “mol % C2 methyl or ethyl branched” refers to the mol percentage of the alkyl chains having either methyl or ethyl branching at the C2 position. “mol % C2 propyl+branched” refers to the mol percentage of the alkyl chains having propyl or higher branching at the C2 position. “mol % 2-Me branched/mol % C2 branched” refers to the ratio of “mol % C2 methyl branched” to “mol % C2 methyl branched”, expressed as a percentage. “mol % 2-Me-C15 branched/mol % 2-C15 branched” refers to the ratio of the mol percentage of C15 alkyl chains having methyl branching at the C2 position to the mol percentage of the C15 alkyl chains having branching at the C2 position.

TABLE 4
Compositions used for the comparative test:
The alcohol blends were converted to alkyl sulfate blends in a falling
film reactor, and then formulated into the following compositions:

| | Ex 1 | Ex A* | Ex B* | Ex C* | Ex D* |
|---|---|---|---|---|---|
| Active level (wt %) | wt % | wt % | wt % | wt % | wt % |
| Sulfated blend 1 | 17.1 | — | — | — | — |
| Sulfated blend A* | — | 17.1 | — | — | |
| Sulfated blend B* | — | — | 17.1 | — | — |
| Sulfated blend C* | — | — | — | 17.1 | — |
| Sulfated blend D* | | | | | 17.1 |
| C12-14 dimethyl amine oxide | 5.7 | 5.7 | 5.7 | 5.7 | 5.7 |
| C9-11 EO8 nonionic | 2.8 | 2.8 | 2.8 | 2.8 | 2.8 |
| surfactant⁶ | | | | | |
| Alkoxylated | 0.4 | 0.4 | 0.4 | 0.4 | 0.4 |
| polyethyleneimine | | | | | |
| (PEI600EO24PO16)⁷ | | | | | |
| Sodium citrate | 2.0 | 2.0 | 2.0 | 2.0 | 2.0 |
| Ethanol | 2.0 | 2.0 | 2.0 | 2.0 | 2.0 |
| Poly-1,2-propylene glycol⁸ | 0.6 | 0.6 | 0.6 | 0.6 | 0.6 |
| Sodium Chloride | 0.7 | 0.7 | 0.7 | 0.7 | 0.7 |
| Water and minors⁹ | to | to | to | to | to |
| | 100% | 100% | 100% | 100% | 100% |
| pH | 9.0 | 9.0 | 9.0 | 9.0 | 9.0 |

⁶sold under the tradename of Neodol ®, supplied by Shell
⁷supplied by BASF
⁸molecular weight 2000 g/mol
⁹Perfume and dye

TABLE 5
Results:
The % C15 in the alkyl sulfate anionic surfactant, as well as
information on the type of branching is repeated below.
The resultant viscosities and grease removal at a typical wash
temperature (46° C.) and at low temperature (22° C.) are also
given in the table below.

| | Ex 1 | Ex A* | Ex B* | Ex C* | Ex D* |
|---|---|---|---|---|---|
| | wt % | wt % | wt % | wt % | wt % |
| mol % C15 in alkyl sulfate | 6.6 | 0.0 | 0.0 | 0.0 | 20 |
| % branching | 38.0 | 30.6 | 34.4 | 47.9 | 47.9 |
| % C2 branching | 15.6 | 8.2 | 12 | 25.4 | 25.4 |
| % C2 methyl branching | 8.9 | 4.9 | 6.6 | 10.7 | 10.7 |
| % 2-Me/% C2-branching | 57 | 60 | 55 | 42 | 42 |
| Neat viscosity mPa · s | 503 | 552 | 573 | 374 | 390 |
| Time required for grease | 11 | 13 | 18 | 10 | 27 |
| lifted off at 46° C. (s) | | | | | |
| Time required for grease | 49 | 209 | 103 | 48 | 124 |
| lifted off at 22° C. (s) | | | | | |

As can be seen from the results above, for detergent compositions comprising C12 to C13 alkyl sulfate anionic surfactant, when the branching is tuned to provide the desired viscosity, it is challenging to provide good grease removal at both warm and cold temperatures (see the results from comparative examples A and B). For detergent compositions comprising C12 to C13 alkyl sulfate anionic surfactant, when the branching is adjusted to provide the desired warm and cold temperature grease removal, the resultant viscosity is lower, resulting in a need to make further formulation adjustments to compensate. In contrast, by adding C15 alkyl sulfate anionic surfactant, at levels required for compositions of the present disclosure, the desired viscosity can be achieved, while also providing both good grease removal at warm temperatures, and good grease removal at cold temperatures. When the mol % C15 in alkyl sulfate is increased to higher than that required for compositions of the present disclosure, a desired viscosity is achieved. However, the grease removal efficacy is reduced both for warm and cold temperature cleaning.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any example disclosed or claimed herein or that it alone, or in any combination with any other reference or references, teaches, suggests or discloses any such example. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of the present disclosure.

What is claimed is:

1. A liquid hand dishwashing cleaning composition comprising from about 5% to about 50% by weight of the total composition of a surfactant system, wherein the surfactant system comprises:
i) from about 40% to about 90% by weight of the surfactant system of alkyl sulfated anionic surfactant selected from the group consisting of: alkyl sulfate, alkyl alkoxy sulfate, and mixtures thereof; and
ii) a co-surfactant selected from the group consisting of an amphoteric surfactant, a zwitterionic surfactant, and mixtures thereof;
characterised in that the alkyl chains of the alkyl sulfate anionic surfactant have a % mol fraction of C12 to C15 chains of at least about 90%, wherein from about 2.0% to about 15% mol fraction of the alkyl chains of the alkyl sulfated anionic surfactant are C15 alkyl chains.

2. The composition according to claim 1, wherein the liquid hand dishwashing cleaning composition comprises from about 8% to about 45% by weight of the total composition of the surfactant system.

3. The composition according to claim 2, wherein the liquid hand dishwashing cleaning composition comprises from about 15% to about 40% by weight of the total composition of the surfactant system.

4. The composition according to claim 1, wherein from about 4.0% to about 10% mol fraction of the alkyl chains of the alkyl sulfated anionic surfactant are C15 alkyl chains.

5. The composition according to claim 1, wherein the alkyl sulfated anionic surfactant has a weight average degree of branching of more than about 10%.

6. The composition according to claim 1, wherein the C15 alkyl chains of the alkyl sulfated anionic surfactant have a weight average degree of branching of more than about 10%.

7. The composition according to claim 6, wherein the C15 alkyl chains of the alkyl sulfated anionic surfactant have a weight average degree of branching of from about 25% to about 60%.

8. The composition according to claim 5, wherein:
a. the C12 alkyl chains of the alkyl sulfated anionic surfactant have a weight average degree of branching of more than about 10%;
b. the C13 alkyl chains of the alkyl sulfated anionic surfactant have a weight average degree of branching of more than about 10%;
c. the C14 alkyl chains of the alkyl sulfated anionic surfactant have a weight average degree of branching of about 0% to about 20%.

9. The composition according to claim 8, wherein:
a. the C12 alkyl chains of the alkyl sulfated anionic surfactant have a weight average degree of branching of from about 15% to about 60%;
b. the C13 alkyl chains of the alkyl sulfated anionic surfactant have a weight average degree of branching of from about 20% to about 60%;
c. the C14 alkyl chains of the alkyl sulfated anionic surfactant have a weight average degree of branching of about 0% to about 15%.

10. The composition according to claim 1, wherein the branched C15 alkyl sulfated anionic surfactant comprises C2 branching at a level of greater than about 60% by weight of the branched C15 alkyl content of the alkyl sulfated anionic surfactant.

11. The composition according to claim1, wherein the C15 alkyl sulfated anionic surfactant comprises 2-branched C15 alkyl sulfated anionic surfactant, wherein the 2-branched C15 alkyl sulfated anionic surfactant has a mol fraction of 2-methyl and 2-ethyl branched C15 alkyl sulfated anionic surfactant of at least about 50%.

12. The composition according to claim 1, wherein the C15 alkyl sulfated anionic surfactant comprises 2-branched C15 alkyl sulfated anionic surfactant, wherein the 2-branched C15 alkyl sulfated anionic surfactant has a mol fraction of 2-methyl branched C15 alkyl sulfated anionic surfactant of at least about 40%.

13. The composition according to claim 12, wherein the C15 alkyl sulfated anionic surfactant comprises 2-branched C15 alkyl sulfated anionic surfactant, wherein the 2-branched C15 alkyl sulfated anionic surfactant has a mol fraction of 2-methyl branched C15 alkyl sulfated anionic surfactant of from 40% to 75%.

14. The composition according to claim 1, wherein the surfactant system comprises less than about 30% by weight of the composition of further anionic surfactant.

15. The composition according to claim 1, wherein the average alkyl chain length of the alkyl sulfated anionic surfactant is from 10 to 14 carbon atoms.

16. The composition according to claim 1, wherein the weight ratio of the alkyl sulfated anionic surfactant to the co-surfactant is from about 1:1 to about 8:1.

17. The composition according to claim 1, wherein the alkyl sulfated anionic surfactant has an average degree of alkoxylation of about 2.0 or less.

18. The composition according to claim 17, wherein the alkyl sulfated anionic surfactant is free of alkoxylation.

19. The composition according to claim 1, wherein the co-surfactant is an amphoteric surfactant, wherein the amine oxide surfactant is selected from the group consisting of: alkyl dimethyl amine oxide, alkyl amido propyl dimethyl amine oxide, and mixtures thereof.

20. A method of manually washing dishware comprising the steps of: delivering the composition according to claim 1 to a volume of water to form a wash solution and immersing the dishware in the solution, wherein the water has a temperature of about 30° C. or less.
